(19) United States
(12) Patent Application Publication
(10) Pub. No.: US 2016/0021857 A1
(43) Pub. Date: Jan. 28, 2016

(54) COLOR ADJUSTABLE FISH ATTRACTING LAMP

(71) Applicant: Genius Electronic Optical Co., Ltd., Taichung City (TW)

(72) Inventor: Chih-Shen LIN, Taichung City (TW)

(21) Appl. No.: 14/794,920

(22) Filed: Jul. 9, 2015

(30) Foreign Application Priority Data
Jul. 22, 2014 (TW) 103125091

(51) Int. Cl. A01K 85/01; F21V 1/14; A01K 97/00; F21L 4/02; F21V 23/00; F21V 23/04; F21V 31/00

(52) U.S. Cl. CPC A01K 85/01; F21V 23/0414; F21V 1/146; F21V 31/005; F21L 4/02; F21V 23/005; A01K 97/00; F21Y 2105/001

(57) ABSTRACT

A color adjustable fish attracting lamp includes a base; and a light emitting diode board disposed at one side of the base. The LED board includes a base board, and a plurality of first light emitting members and second light emitting members. The first light emitting members and second light emitting members produce different lights of different wavelengths, and are capable of being turned on simultaneously or independently so as to produce lights of different wavelengths to attract different fishes. The first and second light emitting members are disposed on the base of the lamp and capable of producing lights of different wavelengths so as to attract different fishes.

### CROSS REFERENCE TO RELATED APPLICATION

This application claims the benefit of priority to TW 103125091, filed on Jul. 22, 2014 with the Intellectual Property Office of the Republic of China, Taiwan, the entire specification of which is incorporated herein by reference.

### BACKGROUND OF THE INVENTION

1. Field of the Invention

The present invention relates to a fish attracting lamp, and more particularly to a color adjustable fish attracting lamp.

2. Description of the Prior Art

Fishing boats are usually provided with fish attracting lamps which project lights onto the seat surface to attract fishes. Conventional fish attracting lamps are mostly tungsten or HID (high intensity discharge) lamps, which are all high power lamps. high power lamps have the disadvantages of high working temperature, high energy consumption and high cost. Therefore, LED (light emitting diode) fish attracting lamps are widely applied in fishing industry due to its advantages of power saving, low working temperature, long life and mercury free.

Since different fishes are attracted to different lights of different wavelengths, a fishing boat must be equipped with many different fish attracting lamps in order to produce different lights of different wavelengths to attract different fishes, which, however, increases the cost.

The present invention has arisen to mitigate and/or obviate the afore-described disadvantages.

### SUMMARY OF THE INVENTION

The present invention is aimed at providing a color adjustable fish attracting lamp capable of producing lights of different wavelengths to attract different fishes.

Therefore, a color adjustable fish attracting lamp in accordance with the present invention includes a base; and a light emitting diode board disposed at one side of the base. The LED board includes a base board, and a plurality of first light emitting members and second light emitting members. The first light emitting members and second light emitting members produce different lights of different wavelengths, and are capable of being turned on simultaneously or independently so as to produce lights of different wavelengths to attract different fishes.

The advantage of the present invention is that: the first and second light emitting members are disposed on the base of the lamp and capable of producing lights of different wavelengths so as to attract different fishes.

### BRIEF DESCRIPTION OF THE DRAWINGS

FIG. 1 is an exploded view of a color adjustable fish attracting lamp in accordance with the present invention;

FIG. 2 is an illustrative view of a LED board of the color adjustable fish attracting lamp in accordance with the present invention;

FIG. 3 is an illustrative view of a first light emitting member of the color adjustable fish attracting lamp in accordance with the present invention; and

FIG. 4 is an illustrative view of a LED board of the color adjustable fish attracting lamp in accordance with another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

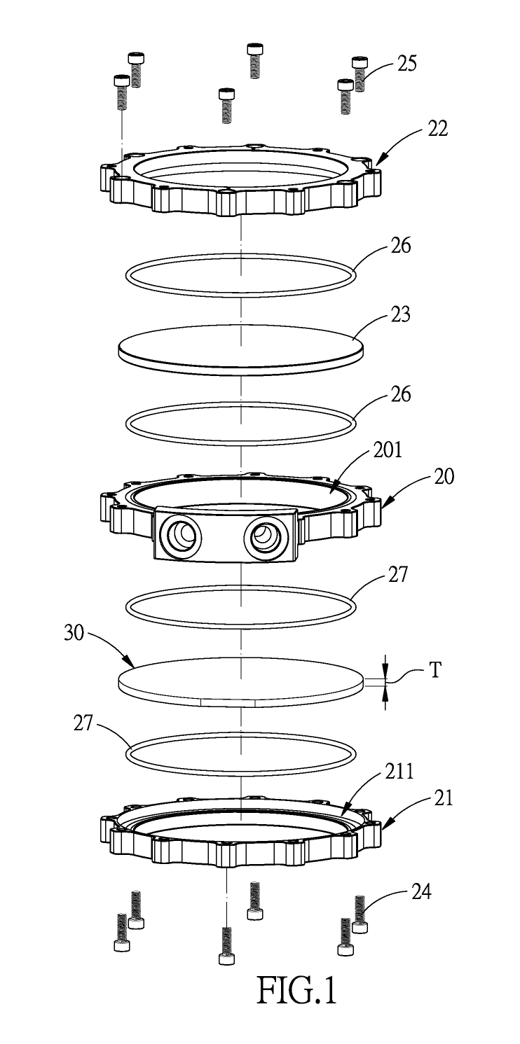

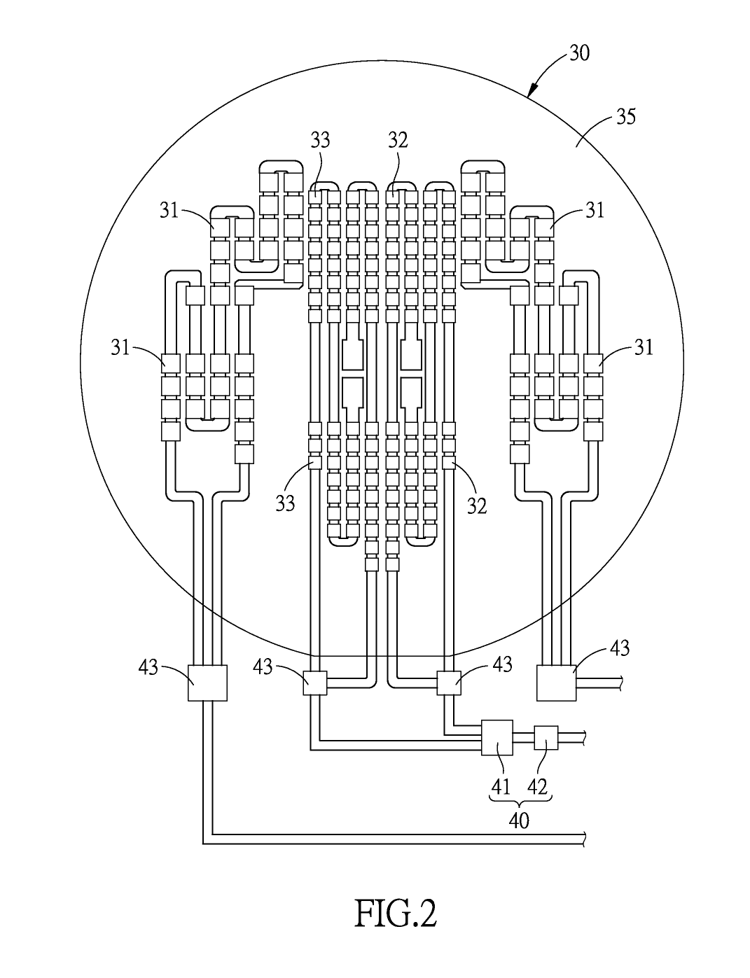

Referring to FIGS. 1-3, a color adjustable fish attracting lamp in accordance with the present invention includes: a base 20, a lower cover 21, an upper cover 22, a lampshade 23, an LED (light emitting diode) board 30 and a control unit 40.

The base 20 is provided for mounting of components. In this embodiment, the base 20 is an annular structure with an inner hole 201.

The lower cover 21 is an annular structure with a chamber 211 formed on the upper surface thereof and fixed to one side of the base 20. More specifically, the lower cover 21 is fixed to the lower side of the base 20 by a plurality of bolts 24. A diameter of the chamber 211 is larger than that of the inner hole 201, so that the LED board 30 can be clamped between the base 20 and the lower cover 21.

The upper cover 22 is an annular structure disposed at one side of the base 20, and more specifically, is fixed to the upper side of the base 20 by a plurality of bolts 25.

The lampshade 23 allows for light penetration and is disposed at another side of the base 20, namely, at the upper side of the base 20 and clamped between the upper cover 22 and the base 20. Between the lampshade 23 and the base 20 is disposed a first waterproof member 26, and between the lampshade 23 and the upper cover 22 is also disposed a first waterproof member 26. The lampshade 23 is waterproof and dustproof and can also take the form of a lens to perform light refraction.

The LED board 30 is disposed in the chamber 211 and clamped between the base 20 and the lower cover 21. The LED board 30 has a diameter larger than a diameter of the inner hole 201 and includes: a base board 35, and a plurality of first light emitting members 31, second light emitting members 32 and third light emitting members 33 which are disposed on the base board 35. The first light emitting members 31, second light emitting members 32 and third light emitting members 33 can produce different lights of different wavelengths, and can be turned on simultaneously or independently by the LED board 30, so as to produce lights of different wavelengths or mix the different wavelength lights to attract different fishes. Between the LED board 30 and the base 20 is disposed a second waterproof member 27, and between the LED board 30 and the lower cover 21 is further disposed a second waterproof member 27. Other embodiments can also just be provided with the first and second light emitting members only.

The lamp in other embodiment of the present invention is not provided with the upper and lower covers 22, 21 and the waterproof members 26, 27, and the base 20 is not provided with the inner hole 201, while the LED board 30 is disposed at the upper side of the base 20, and the lampshade is provided at the upper side of the LED board 30.

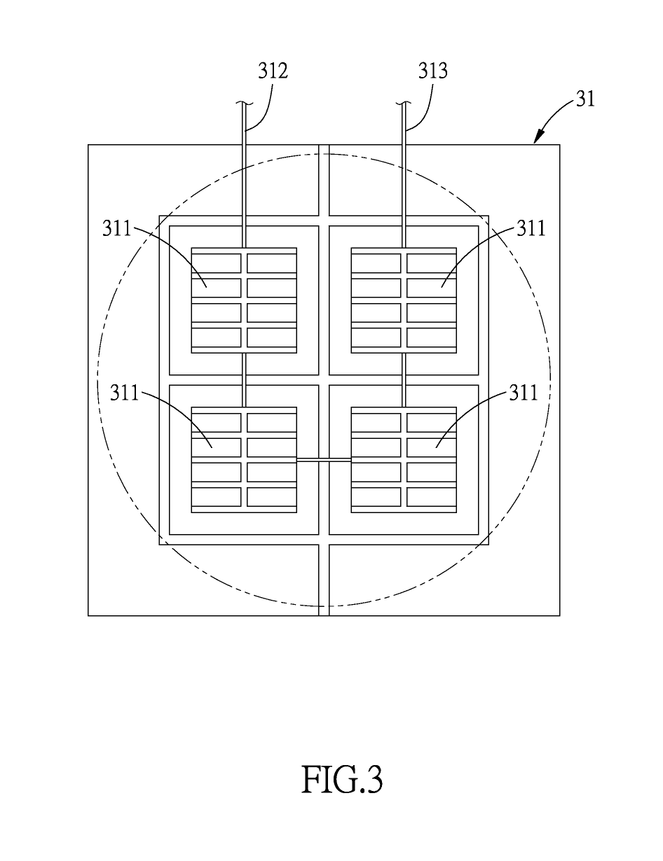

In each of the first light emitting members 31 is provided a plurality of LED chips 311 (as shown in FIG. 3), and the LED chips 311 have been serially connected (namely, multi-chip package) when packing the first light emitting members 31, so that each of the first light emitting members 31 has a single power input portion 312 and a single power output portion 313. Each of the first light emitting members 31 has the power input portion 312 electrically connected to the power output portion 313 of a neighboring first light emitting member 31 and has the power output portion 313 electrically connected to the power input portion 312 of another neighboring first light emitting member 31. Each of the first light emitting members 31 is driven by high voltage. In this embodiment, there are four LED chips 311, but there can also be eight LED chips 311 in other embedment.

Each of the second light emitting members 32 is only provided with one LED chip, and includes a single power input portion and a single power output portion (not shown). Each of the second light emitting members 32 has the power input portion electrically connected to the power output portion of a neighboring second light emitting member and has the power output portion electrically connected to the power input portion of another neighboring second light emitting member.

Each of the third light emitting members 33 is only provided with one LED chip, and includes a single power input portion and a single power output portion (not shown). Each of the third light emitting members 33 has the power input portion electrically connected to the power output portion of a neighboring third light emitting member and has the power output portion electrically connected to the power input portion of another neighboring third light emitting member.

It is to be noted that in other embodiments, the second, third light emitting members 32, 33 can also be provided with multiple chips, like the first light emitting members 31.

In this embodiment, the first light emitting members 31 produce a first light with a wavelength of 630 nm to 680 nm to attract the fish, such as saury. This embodiment is provided with more first light emitting member 31 than the second and third light emitting members, so that when only the first light emitting members 31 need to be turned on to produce enough first light to attract the saury fish.

In this embodiment, the second light emitting members 32 are LEDs which produce green light, and the third light emitting members 33 are LEDs for producing white light. When the first, second and third light emitting members 31 are turned on simultaneously, a mixed light which is greenish white with a color temperature of 3500 k to 5000 k will be produced, and this is the wavelength of the light that most of the fishes like. Of course, the light emitting members can also be other LEDs for producing lights of other wavelengths.

In this embodiment, the base board 35 of the LED board 30 is made of aluminum oxide, which has the advantages of good heat dissipation, low cost and easy to produce. The base board 35 is made of glass ceramics, aluminum nitride, or silicon nitride, and the base board 35 can be, but not limited to, circular shaped. The base board 35 has a thickness T ranging from 1 mm to 6 mm, and preferably 2 mm to 5 mm.

The control unit 40 controls on and off of the second and third light emitting members 32, 33, and controls the brightness of the lights produced by the second and third light emitting members 32, 33. In this embodiment, the control unit 40 includes a solenoid switch 41 and a rotary button 42 electrically connected to the solenoid switch 41. The circuits of the second and third light emitting members 32, 33 are connected to a rectifier 43, respectively, and then connected to the solenoid switch 41 of the control unit 40, the solenoid switch 41 can control on and off of the first, second and third light emitting members 32, 33, so that the rotary button 42 can control the brightness of the light produced by the second and third light emitting members 32, 33 through the solenoid switch 41. Each of the first light emitting members 31 is connected to the power source via a rectifier 43, therefore, the first light emitting members 31 will be turned on by turning on the power source. The control unit 40 can be used to turn on the second and third light emitting members 32, 33, and the lights produced from the second and third light emitting members 32, 33 will be mixed into a greenish white color after passing through the LED board 30, or the second and third light emitting members 32, 33 can be adjusted independently to produce different mixed lights. When the second and third light emitting members 32, 33 are switched off by the control unit 40, only the first light emitting members 31 will produce light.

What mentioned above are the structural relations of the main components of the embodiment, and for a better understanding of the operation and function of the present invention, reference should be made to FIGS. 1-3 again, the first, second and third light emitting members 31, 32, 33 can be turned on simultaneously or independently, so that the color adjustable lamp of the present invention is capable of producing different lights of different wavelengths to attract different fishes, which can reduce the number of fish attracting lamps used in a fishing boat.

Since the fish attracting lamp requires high power, such as 1000 W in the above embodiment, the more LED the better. Increasing the size of the base board 35 can increase the number of LEDs mounted thereon, which, however, will also increase the size and weight of the fish attracting lamp. Therefore, the size of the base board 35 cannot be increased unlimitedly. Hence, the first light emitting members 31 are each packed by multi-chip package, wherein the LED chips 311 inside each of the first light emitting members 31 are connected in series in advance to make the first light emitting member 31 has only a single power input portion 312 and a single power output portion 313, then high voltage is used to drive the LED chips 311. By such arrangements, not only the lamp has a high power, but also the wiring arrangement is also very simple to restrict the base board 35 in a desired size. In this embodiment, the drive voltage of the first light emitting members 31 is 280V to 380 V, and the drive voltage of the second and third light emitting members 32, 33 is 160 V to 240V.

The thickness T of the base board 35 influences heat dissipation performance, the thinner the thickness T the better the heat dissipation. However, the thinner the thickness T, the more likely to broke and leakage the base board 35 will be. The author of this application finds that the heat dissipation and durability are best balanced when the thickness T is 1 mm to 6 mm, preferably, 2 mm to 5 mm.

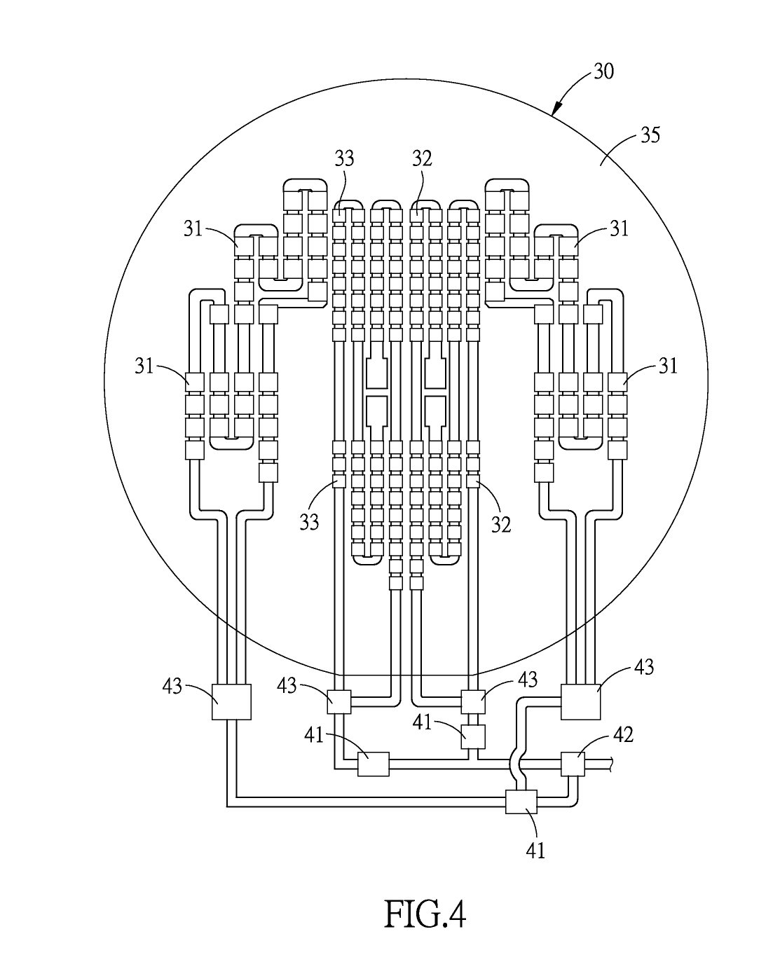

Referring then to FIG. 4, the control unit 40 controls on and off of the second and third light emitting members 32, 33, and controls the brightness of the lights produced by the first, second and third light emitting members 31, 32, 33. In this embodiment, the control unit 40 includes a solenoid switch 41 and a rotary button 42 electrically connected to the solenoid switch 41. The circuits of the first, second and third light emitting members 31, 32, 33 are connected to a rectifier 43, respectively, and then connected to the solenoid switch 41 of the control unit 40, the solenoid switch 41 can control on and off of the first, second and third light emitting members 31, 32, 33, so that the rotary button 42 can control the brightness of the light produced by the first, second and third light emitting members 31, 32, 33 through the solenoid switch 41. Each of the first light emitting members 31 is connected to the power source via a rectifier 43, therefore, the first light emitting members 31 will be turned on by turning on the power source. The control unit 40 can be used to turn on the first, second and third light emitting members 31, 32, 33, and the lights produced from the first, second and third light emitting members 31, 32, 33 will be mixed into a greenish white color after passing through the LED board 30, or the first, second and third light emitting members 31, 32, 33 can be adjusted independently to produce different mixed lights.

While we have shown and described various embodiments in accordance with the present invention, it is clear to those skilled in the art that further embodiments may be made without departing from the scope of the present invention.

What is claimed is:

1. A color adjustable fish attracting lamp comprising:
a base; and
a light emitting diode board disposed at one side of the base and including: a base board, and a plurality of first light emitting members and second light emitting members, the first light emitting members and second light emitting members producing different lights of different wavelengths, and capable of being turned on simultaneously or independently so as to produce lights of different wavelengths to attract different fishes.

2. The color adjustable fish attracting lamp as claimed in claim 1 further comprising a control unit which controls on and off of the first and second light emitting members.

3. The color adjustable fish attracting lamp as claimed in claim 2, wherein each of the first light emitting members is provided with a plurality of light emitting diode chips, and each of the first light emitting members includes a single power input portion and a single power output portion, each of the first light emitting members has the power input portion electrically connected to the power output portion of a neighboring first light emitting member and has the power output portion electrically connected to the power input portion of another neighboring first light emitting member, and a drive voltage of the first light emitting members is larger than 250 V.

4. The color adjustable fish attracting lamp as claimed in claim 3, wherein the quantity of the first light emitting members is larger than that of the second light emitting members, the first light emitting members produce a first light of a wavelength ranging from 630 nm to 680 nm.

5. The color adjustable fish attracting lamp as claimed in claim 4, wherein the light emitting diode board further comprises a plurality of third light emitting members disposed on the base board, the control unit controls on and off of the third and second light emitting members, the second light emitting members are light emitting diodes for producing green light, and the third light emitting members are light emitting diodes for producing white light, when the first, second and third light emitting members are turned on simultaneously, a mixed light which is greenish white with a color temperature of 3500 k to 5000 k will be produced.

6. The color adjustable fish attracting lamp as claimed in claim 1, wherein the base board has a thickness ranging from 1 mm to 6 mm.

7. The color adjustable fish attracting lamp as claimed in claim 6, wherein the thickness is 2 mm to 5 mm.

8. The color adjustable fish attracting lamp as claimed in claim 6, wherein the base board is made of aluminum oxide.

9. The color adjustable fish attracting lamp as claimed in claim 1 further comprising a lampshade disposed at another side of the base, between the lampshade and the base is disposed a first waterproof member, and between the light emitting diode board and the base is disposed a second waterproof member.

10. The color adjustable fish attracting lamp as claimed in claim 1, wherein each of the first light emitting members are packaged light emitting diodes.
